(19) United States
(12) Patent Application Publication
(10) Pub. No.: US 2022/0298947 A1
(43) Pub. Date: Sep. 22, 2022

(54) HONEYCOMB SUBSTRATE WITH ELECTRODE

(71) Applicant: DENSO CORPORATION, Kariya-city (JP)

(72) Inventor: Koji KASAI, Kariya-city (JP)

(21) Appl. No.: 17/837,234

(22) Filed: Jun. 10, 2022

Related U.S. Application Data
(63) Continuation of application No. PCT/JP2020/042886, filed on Nov. 18, 2020.

(30) Foreign Application Priority Data
Dec. 11, 2019 (JP) 2019-223867

(51) Int. Cl. F01N 3/28

(52) U.S. Cl. CPC F01N 3/2828; F01N 2330/06; F01N 2330/34

(57) ABSTRACT

A honeycomb substrate with an electrode includes a conductive ceramic honeycomb substrate that generates heat by energization and a pair of electrodes that is provided to face an outer periphery of the honeycomb substrate. A coefficient of thermal expansion of the electrode is higher than a coefficient of thermal expansion of the honeycomb substrate.

### CROSS-REFERENCE TO RELATED APPLICATION

The present application is based on and claims the benefit of priority from earlier Japanese Patent Application No. 2019-223867 filed on Dec. 11, 2019, the description of which is incorporated herein by reference.

### BACKGROUND

### Technical Field

The present disclosure relates to a honeycomb substrate with an electrode.

### Related Art

Regarding a catalytic device provided to an exhaust pipe to purify exhaust gas generated in an internal-combustion engine, a technique is known in which a honeycomb substrate supporting a catalyst is electrically heated to cause the honeycomb substrate to generate heat. In this case, since a voltage is applied to the honeycomb substrate, a pair of electrodes facing an outer periphery of the honeycomb substrate is provided.

### SUMMARY

An aspect of the present disclosure provides a honeycomb substrate with an electrode. The honeycomb substrate includes: a conductive ceramic honeycomb substrate that generates heat by energization; and a pair of electrodes that is provided to face an outer periphery of the honeycomb substrate. A coefficient of thermal expansion of the electrode is higher than a coefficient of thermal expansion of the honeycomb substrate.

### BRIEF DESCRIPTION OF THE DRAWINGS

In the accompanying drawings:

FIG. 1 is a schematic cross-section diagram of a honeycomb substrate with an electrode in a direction orthogonal to a direction of a gas flow, according to an embodiment;

FIG. 2 is a schematic diagram of an example of an electric heating-type catalytic device to which the honeycomb substrate with an electrode according to the embodiment is applied;

FIG. 3 is a diagram illustrating a simulation model of the honeycomb substrate with an electrode according to a first experimental example; and

FIG. 4 is a diagram illustrating a relationship between a coefficient of thermal expansion of an electrode/a coefficient of thermal expansion of a honeycomb substrate (horizontal axis) and a generated stress ratio (vertical axis).

### DETAILED DESCRIPTION OF THE PREFERRED EMBODIMENTS

Regarding a catalytic device provided to an exhaust pipe to purify exhaust gas generated in an internal-combustion engine, a technique is known in which a honeycomb substrate supporting a catalyst is electrically heated to cause the honeycomb substrate to generate heat. In this case, since a voltage is applied to the honeycomb substrate, a pair of electrodes facing an outer periphery of the honeycomb substrate is provided.

For example, Japanese Patent No. 5246337 discloses a catalytic device for purifying exhaust gas. The catalytic device includes a substrate including SiC, an underlayer having electrical conductivity and joined to an outer wall of the substrate, and an electrode fixed to an outer surface of the underlayer. The underlayer has a coefficient of thermal expansion between the coefficient of thermal expansion of the substrate and the coefficient of thermal expansion of the electrode. Japanese Patent No. 5246337 states that when the device is continuously used in an environment in which temperature change such as a cooling/heating cycle occurs, the electrodes can be prevented from being detached from the substrate due to heat stress applied to a junction surface between the electrode and the substrate.

According to the above technique, in short, when the substrate and the electrode having respective coefficients of thermal expansion different from each other are joined, the underlayer having a coefficient of thermal expansion between the coefficient of thermal expansion of the substrate and the coefficient of thermal expansion of the electrode is provided between the substrate and the electrode to reduce heat stress generated due to the difference of thermal expansion caused between the substrate and the electrode in a cooling/heating cycle. However, the above technique does not at all describe suppressing heat stress generated at the time of electrical heating.

An object of the present disclosure is to provide a honeycomb substrate with an electrode that can reduce heat stress which is generated by the difference of thermal expansion due to the temperature difference between a substrate and an electrode caused when mainly the substrate is heated by energization.

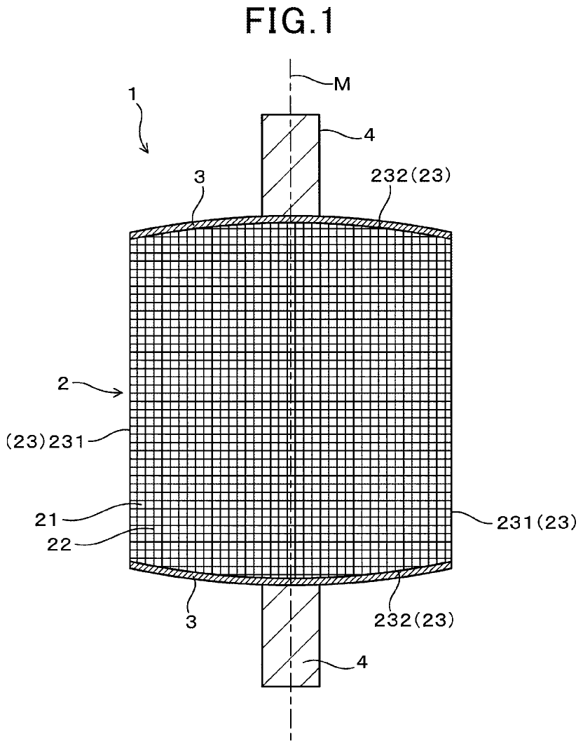

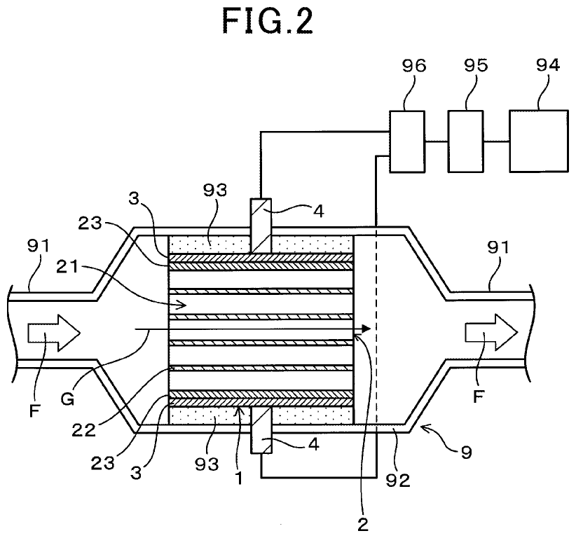

A honeycomb substrate with an electrode according to an embodiment will be described with reference to FIG. and FIG. 2. As illustrated in FIG. 1, a honeycomb substrate 1 with an electrode of the present embodiment has a conductive ceramic honeycomb substrate 2 that generates heat by energization and a pair of electrodes 3 provided to face an outer periphery of the honeycomb substrate 2. In the honeycomb substrate 1 with an electrode, a coefficient of thermal expansion of the electrode 3 is higher than a coefficient of thermal expansion of the honeycomb substrate 2 (the coefficient of thermal expansion of the honeycomb substrate 2 is lower than the coefficient of thermal expansion of the electrode 3.

According to the honeycomb substrate 1 with an electrode of the present embodiment, heat stress can be reduced which is generated by the difference of thermal expansion due to the temperature difference between the honeycomb substrate 2 and the electrode 3 caused when mainly the honeycomb substrate 2 is heated by energization. The reason of this will be described below.

In an electric heating-type catalytic device 9 illustrated in FIG. 2, it is preferable to mainly heat the honeycomb substrate 2 from the viewpoint of improvement in the efficiency of temperature rising of the honeycomb substrate 2. Under such a condition, the temperature distribution of the honeycomb substrate 2 due to electrical heating becomes higher than the temperature distribution of the electrode 3. That is, in this case, the honeycomb substrate 1 with an electrode is heated so that the relationship, an average temperature of the honeycomb substrate 2>an average temperature of the electrode 3, is established until the whole of the honeycomb substrate 1 is heated by electrical heat generation and heat transfer.

The honeycomb substrate with an electrode in which a coefficient of thermal expansion of the honeycomb substrate 2 is equal to a coefficient of thermal expansion of the electrode 3 is used as a honeycomb substrate with an electrode (not shown) of a comparative embodiment. In the honeycomb substrate with an electrode of the comparative embodiment, if the temperature of the honeycomb substrate 2 becomes higher than the temperature of the electrode 3 by energization, the amount of thermal expansion of the honeycomb substrate 2 becomes large because the coefficient of thermal expansion of the honeycomb substrate 2 is the same as that of the electrode 3, whereas the amount of thermal expansion of the electrode 3 remains small. As a result, in the honeycomb substrate with an electrode of the comparative embodiment, at the time of electrical heat generation, the difference of thermal expansion between the honeycomb substrate 2 and the electrode 3 becomes large, and the amount of thermal strain (≈heat stress value) becomes large. That is, in the honeycomb substrate with an electrode of the comparative embodiment, heat stress cannot be reduced which is generated by the difference of thermal expansion caused due to the temperature difference between the honeycomb substrate 2 and the electrode 3 caused when mainly the honeycomb substrate 2 is heated by energization.

In contrast, in the honeycomb substrate 1 with an electrode of the present embodiment, if the temperature of the honeycomb substrate 2 becomes higher than the temperature of the electrode 3 by energization, the amount of thermal expansion of the honeycomb substrate 2 is suppressed to be small because the coefficient of thermal expansion of the electrode 3 is higher than that of the honeycomb substrate 2, whereas the amount of thermal expansion of the electrode 3 becomes large. As a result, in the honeycomb substrate 1 with an electrode of the present embodiment, at the time of electrical heat generation, the difference of thermal expansion between the honeycomb substrate 2 and the electrode 3 becomes small, and the amount of thermal strain heat stress value) becomes small. That is, in the honeycomb substrate 1 with an electrode of the present embodiment, heat stress can be reduced which is generated by the difference of thermal expansion due to the temperature difference between the honeycomb substrate 2 and the electrode 3 caused when mainly the honeycomb substrate 2 is heated by energization. In addition, according to the honeycomb substrate 1 with an electrode of the present embodiment, since heat stress is reduced which is due to the temperature distribution generated by the temperature rise due to is electrical heat generation, a heat generation function can be easily prevented from being lost or deteriorated due to occurrence of cracking or the like, thereby providing the honeycomb substrate 1 with an electrode having high repetitive usability. It is noted that the conventional technique described above intends to reduce heat stress generated between a substrate and an electrode having different coefficients of thermal expansion but does not intend to reduce heat stress accompanying the temperature rise due to electrical heat generation.

The coefficient of thermal expansion of the honeycomb substrate 2 and the coefficient of thermal expansion of the electrode 3 are measured as below. A substrate sample is cut out from the honeycomb substrate 2. In addition, an electrode sample is cut out from the electrode 3. When the honeycomb substrate 2 and the electrode 3 are joined as described later, an electrode sample is cut out from the electrode 3 cut off the honeycomb substrate 2. Each sample is cut off so as to have a length of 5 mm or more. Thermo-mechanical analyzer is used to increase temperature at a rate of temperature increase of 10° C./min. after each sample length at 25° C. is measured and record a rate of change of each sample length with respect to temperature. As the thermo-mechanical analyzer, a Thermo plus EVO2 manufactured by Rigaku Corporation may be used. Then, the average rate of change of a substrate sample length from 25° C. to 800° C. is defined as a coefficient of thermal expansion (ppm/K) of the honeycomb substrate 2. Specifically, the coefficient of thermal expansion of the honeycomb substrate 2 is calculated by the expression, (sample length (mm) at 800° C.−sample length (mm) at 25° C.)/(sample length (mm) at 25° C.)/(800 (° C.)−25 (° C.))*1000000. The average rate of change of an electrode sample length from 25° C. to 800° C. is defined as a coefficient of thermal expansion (ppm/K) of the electrode 3. Specifically, the coefficient of thermal expansion of the electrode 3 is calculated by the expression, (sample length (mm) at 800° C.−sample length (mm) at 25° C.)/(sample length (mm) at 25° C.)/(800 (° C.)−25 (° C.))*1000000.

In the honeycomb substrate 1 with an electrode, the ratio between the coefficient of thermal expansion of the honeycomb substrate 2 and the coefficient of thermal expansion of the electrode 3 may be in a range of 1:1.1 to 1:3. According to this configuration, even when the honeycomb substrate 1 with an electrode is heated so that the relationship, a temperature of the honeycomb substrate 2>a temperature of the electrode 3, is established until the whole honeycomb substrate 1 is heated by electrical heat generation and heat transfer, heat stress generated by the temperature difference at that time can be easily reduced. The ratio between the coefficient of thermal expansion of the honeycomb substrate 2 and the coefficient of thermal expansion of the electrode 3 may be preferably in a range of 1:1.1 to 1:2.8, further preferably in a range of 1:1.1 to 1:2.5, and still further preferably in a range of 1:1.1 to 1:2.

The honeycomb substrate 1 with an electrode can be configured to establish the relationship, Qₕ/Cₕ>Qₑ/Cₑ, where a Joule heating value of the honeycomb substrate 2 per hour at the time of energization is Qₕ, a heat capacity of the honeycomb substrate 2 is Cₕ, a Joule heating value of the electrode 3 per hour at the time of energization is Qe, and a heat capacity of the electrode 3 is Cₑ. According to the indicators, Qₕ/Cₕ and Qₑ/Cₑ, the temperature rise of the honeycomb substrate 2 and the temperature rise of the electrode 3 can be compared with each other with a contribution of the temperature rise due to heat conduction being eliminated. If the relationship Qₕ/Cₕ>Qₑ/Cₑ is established, since the temperature rise of the honeycomb substrate 2 is larger than the temperature rise of the electrode 3, the honeycomb substrate 2 is heated earlier by energization, whereby the temperature of the electrode 3 becomes low. Hence, according to the above configuration, in such a state, heat stress generated by the difference of thermal expansion caused due to the temperature difference between the honeycomb substrate 2 and the electrode 3 can be reliably reduced. According to the above configuration, since the temperature of the honeycomb substrate 2 can be mainly increased rather than that of the electrode 3 by energization, a supported catalyst can be activated by low input energy.

In the honeycomb substrate 1 with an electrode, the ratio between the heat capacity of the honeycomb substrate 2 and the heat capacity of the electrode 3 may be in a range of 10:1 to 300:1. According to this configuration, since the heat capacity of the electrode 3 is lower than the heat capacity of the honeycomb substrate 2, the amount of heat consumed on the honeycomb substrate 2 side becomes large, whereby mainly the honeycomb substrate 2 can be heated, easily. In addition, according to this configuration, since the thickness of the electrode by which the electrode is preferably formed is easily ensured, the honeycomb substrate 1 with an electrode can be provided with high manufacturability. The ratio between the heat capacity of the honeycomb substrate 2 and the heat capacity of the electrode 3 may be preferably in a range of 20:1 to 250:1, further preferably in a range of 30:1 to 200:1, and still further preferably in a range of 50:1 to 150:1.

In the honeycomb substrate 1 with an electrode, the honeycomb substrate 2 may be configured by conductive ceramic. Specifically, the honeycomb substrate 2 may be configured by conductive ceramic including silicon particles. Since the honeycomb substrate 2 includes silicon particles as conductive particles, the honeycomb substrate 1 with an electrode can be easily provided which can reduce heat stress generated at the time of electrical heat generation while ensuring electrical conductivity and electrical resistance suited to an electric heating-type catalytic device.

In the honeycomb substrate 1 with an electrode, the electrode 3 may be configured by conductive ceramic. Specifically, the electrode 3 may be configured by conductive ceramic including silicon particles. Since the electrode 3 includes silicon particles as conductive particles, a resistance value of an electrode material can be easily adjusted.

In the honeycomb substrate 1 with an electrode, when each of the honeycomb substrate 2 and the electrode 3 includes silicon particles, the junction between the honeycomb substrate 2 and the electrode 3 described later becomes tighter. It can be considered that this is because when each of the honeycomb substrate 2 and the electrode 3 includes silicon particles, part of the honeycomb substrate 2 and part of the electrode 3 are melted and joined to each other at the time of firing.

In the honeycomb substrate 1 with an electrode, at least one of the honeycomb substrate 2 and the electrode 3 may be configured to include oxide including silicon and boron (hereinafter, referred to as Si/B-containing oxide). According to this configuration, since the Si/B-containing oxide can complement formation of a conductive path with silicon particles, conductivity can be easily improved. Preferably, from the view point of conductivity, resistance temperature characteristics, and durability, each of the honeycomb substrate 2 and the electrode 3 may include Si/B-containing oxide. The Si/B-containing oxide can be present so as to cover the outer periphery of the successive silicon particles.

The honeycomb substrate 2 and the electrode 3 may further include an insulating ceramic material. Examples of the ceramic material include alumina, titania, silica, molten silica, and cordierite. One or two or more of these may be contained. Specifically, molten silica may be preferably used as the insulating ceramic material because the coefficient of thermal expansion of the material can be low, and heat stress generated due to the temperature distribution in the member can be small. Molten silica may be contained in at least one of the honeycomb substrate 2 and the electrode 3, and is preferably contained in the honeycomb substrate 2.

In the honeycomb substrate 1 with an electrode, the electrode 3 may be joined to the honeycomb substrate 2, or may be brought into contact with the honeycomb substrate 2 in a pressed state. Preferably, the electrode 3 may be joined to the honeycomb substrate 2. In this case, since the honeycomb substrate 2 is held by the electrode 3, stress is typically generated easily. However, even in this case, employing the configuration in which the coefficient of thermal expansion of the electrode 3 is higher than the coefficient of thermal expansion of the honeycomb substrate 2 can sufficiently achieve the effects described above. When the electrode 3 is joined to the honeycomb substrate 2, compared with a case in which the electrode 3 is not joined to the honeycomb substrate 2, the interface resistance between the electrode 3 and the honeycomb substrate 2 can be easily low, whereby heat generation can be easily suppressed at the interface portion.

The electrode 3 may be directly joined to the honeycomb substrate 2, or maybe joined to the honeycomb substrate 2 via a junction layer (not shown). The electrode 3 may be joined to the honeycomb substrate 2 either chemically or physically. Examples of the chemical junction include the junction between a honeycomb substrate material and an electrode material produced by sintering and the junction produced by a junction material that can be sintered to a honeycomb substrate material and an electrode material. Examples of the physical junction include the junction produced by a mixture of an adhesive (bond) and an electrically conducting material.

In the honeycomb substrate 1 with an electrode, as illustrated in FIG. 1, the honeycomb substrate 2 may typically include partitions 22 forming a plurality of cells 21 with partitions and a peripheral wall 23 surrounding the outer peripheries of the partitions 22. The cell 21 is a flow path through which an exhaust gas F shown in FIG. 2 flows. For example, FIG. 1 illustrates an example in which the partitions 22 form the plurality of square cells 21 with partitions in a cross section orthogonal to a gas flow direction G shown in FIG. 2 (hereinafter, also simply referred to as orthogonal cross section). That is, in FIG. 1, the partitions 22 are formed in a grid. The partitions 22 may be configured so as to form the plurality of cells 21 having a known shape, for example, a plurality of cells having a hexagonal shape, with partitions. In FIG. 1, the partitions 22 are expressed by lines for convenience sake, and wall thickness and the like is not shown.

FIG. 1 illustrates an example in which the peripheral wall 23 has a pair of side surface parts 231 and a pair of electrode forming surface parts 232. The pair of side surface parts 231 is disposed in parallel in a state of being separated from each other. The wording parallel herein does not strictly mean that the pair of side surface parts 231 is geometrically parallel to each other but means that the pair of side surface parts 231 can be considered to be parallel to each other. The pair of electrode forming surface parts 232 is disposed to face each other in a state of being separated from each other. The pair of electrode forming surface parts 232 connects edges on the same sides of the pair of side surface parts 231 to each other. That is, one of the pair of electrode forming surface parts 232 connects the edges on the first same sides of the pair of side surface parts 231 to each other, and the other of the pair of electrode forming surface parts 232 connects the edges on the second same sides, which are opposite to the first same sides, of the pair of side surface parts 231 to each other. Specifically, as illustrated in FIG. 1, the partitions 22 are surrounded by the peripheral wall 23 on which the edges of one of the surface parts 231, one of the electrode forming surface parts 232, the other of the surface parts 231, and the other of the electrode forming surface parts 232 are connected to each other and are integrally held by the peripheral wall 23. The cross-section shape of the honeycomb substrate 2 illustrated in FIG. 1 may be a so-called race track shape. Although not shown, the cross-section shape of the honeycomb substrate 2 may be, for example, a circular shape, an elliptical shape, or a rectangular shape.

In FIG. 1, the pair of electrodes 3 is provide to face the surface of the peripheral wall 23. Specifically, the electrodes 3 respectively cover the surfaces of the electrode forming surface parts 232. More specifically, each of the electrodes 3 is formed to reach both ends of the electrode forming surface part 232 in the orthogonal cross section. The electrodes 3 may not be formed to reach both ends of the electrode forming surface part 232.

The honeycomb substrate 1 with an electrode may be configured so as to be electrically heated in a state in which a pair of electrode terminals 4 is electrically connected to the pair of electrodes 3. As illustrated in FIG. 1, the pair of electrode terminals 4 may be disposed on a center line M passing between the center points on the respective surfaces of the pair of electrode forming surface parts 232. The electrode terminals 4 may be joined to the electrodes 3 or may not be joined to the electrodes 3.

As illustrated in FIG. 2, for example, in a state in which the honeycomb substrate 1 with an electrode supports a catalyst (platinum, palladium, rhodium, and the like), the honeycomb substrate 1 with an electrode may be applied to the electric heating-type catalytic device 9 provided to an exhaust pipe 91 for purifying the exhaust gas F generated in an internal-combustion engine (not shown). In FIG. 2, the direction of the arrow G is the direction of a gas flow in the honeycomb substrate 1 with an electrode. Specifically, the exhaust gas F flows into the cells 21 from an end face on the upstream side of the honeycomb substrate 2 and flows in the cells 21 along the direction G of the gas flow, and thereafter the gas is discharged from an end face on the downstream side of the honeycomb substrate 2.

Specifically, FIG. 2 illustrates an example in which a case cylinder 92 is fixed in the middle of the exhaust pipe 91, and the honeycomb substrate 1 with an electrode is accommodated in the case cylinder 92. FIG. 2 illustrates an example in which a holding member 93 having insulating properties is disposed between the honeycomb substrate 1 with an electrode and the case cylinder 92. In FIG. 2, the electrodes 3 of the honeycomb substrate 1 with an electrode are electrically connected with the electrode terminals 4, respectively. Applying a voltage between the pair of electrodes 3 via the pair of electrode terminals 4 can cause the honeycomb substrate 2 to electrically generate heat. Although FIG. 2 illustrates an example of the configuration in which electrical power from a power supply 94 such as a battery is fed to the pair of electrode terminals 4 via a switching circuit 95 and a breaking circuit 96, this is not the limitation. The system of applying a voltage may be any of a DC system, an AC system, a pulse system, and the like.

### First Experimental Example

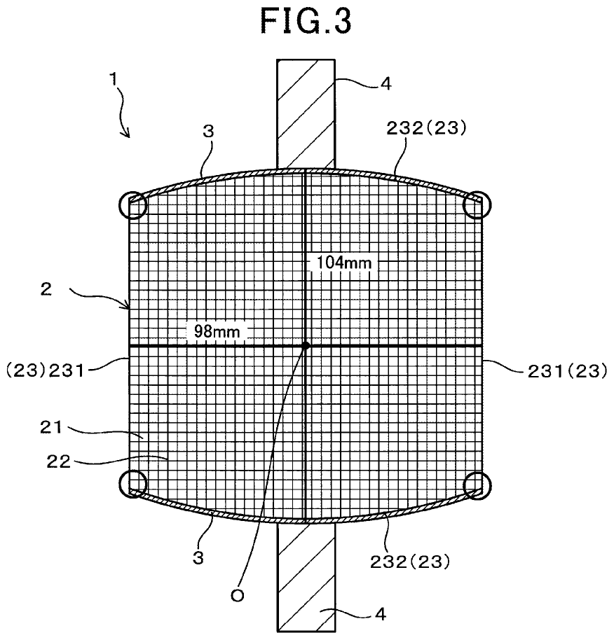

A model of the honeycomb substrate 1 with an electrode having a cross-section shape illustrated in FIG. 3 was used to change the coefficient of thermal expansion of the electrode 3 with respect to the coefficient of thermal expansion of the honeycomb substrate 2 to calculate, in a simulation, a value of the maximum stress generated at the time of electrical heat generation. Conditions for the simulation was as below. Specifically, the honeycomb substrate 2 has a shape in which the distance between the electrode forming surface parts 232 through the center O of the substrate is 104 mm, the distance between the side surface parts 231 through the center O of the substrate is 98 mm, the depth of the substrate is 60 mm, the wall thickness of the partition 22 is 0.132 mm, and the width of the cell 21 is 1.14 mm. Two ends of the electrodes 3 reach the side surface parts 231 and do not protrude from the surface lines of the side surface parts 231 in a state of being aligned with the surface lines of the side surface parts 231. The film thickness of the electrode 3 was 1.0 mm. The ratio of heat capacities between the honeycomb substrate 2 and the electrode 3 was 20:1. The electrical resistance of the honeycomb substrate was 10Ω. The electrical resistance of the electrode was 0.3Ω. As the maximum stress, a value of the maximum stress was used which is generated at the time point until which the electrical energy of 8 kW is applied to the honeycomb substrate 1 with an electrode through the electrode terminals 4 for 20 sec.

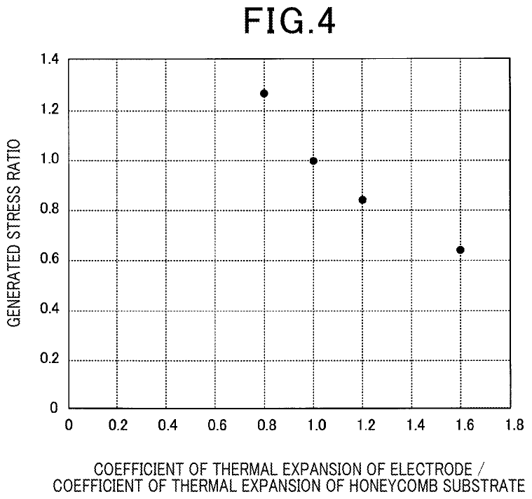

FIG. 4 illustrates a result of the above simulation. In FIG. 4, the horizontal axis indicates a ratio of the coefficient of thermal expansion of the electrode to the coefficient of thermal expansion of the honeycomb substrate and is simply represented as “coefficient of thermal expansion of electrode/coefficient of thermal expansion of honeycomb substrate”. In FIG. 4, the vertical axis indicates a ratio of the maximum stress generated when the coefficient of thermal expansion of the electrode is changed with respect to the coefficient of thermal expansion of the honeycomb substrate, to the maximum stress generated when the coefficient of thermal expansion of the honeycomb substrate is the same as the coefficient of thermal expansion of the electrode, and is simply represented as “generated stress ratio”.

As illustrated in FIG. 4, the ratio of coefficient of thermal expansion of electrode/coefficient of thermal expansion of honeycomb substrate is higher than 1. That is, it can be understood that as the coefficient of thermal expansion of the electrode becomes higher than the coefficient of thermal expansion of the honeycomb substrate, the generated stress ratio becomes lower. From this result, according to the honeycomb substrate with an electrode of the present disclosure, it was confirmed that heat stress can be reduced which is generated by the difference of thermal expansion due to the temperature difference between the honeycomb substrate and the electrode caused when mainly the honeycomb substrate is heated by energization. In the present experimental example, a so-called race track shape is used as the cross-section shape of the honeycomb substrate to perform the simulation. However, similar results can be obtained even when other cross-section shapes such as an elliptical shape and a rectangular shape are used. This is also applied to the shape of the electrode.

### Second Experimental Example

### Preparation of Sample 1 to Sample 3

Si powder, boric acid powder, and kaolin powder were combined in the mass ratio of 60:4:36, and water was added to and mixed with the combination. Next, after the obtained mixture was shaped, the mixture was fired at 1250° C. in an Ar gas atmosphere at normal pressure to prepare bulk bodies A having a shape of 30 mm*50 mm*5 mm. In the present example, kaolin is used as insulating ceramic material powder. Instead of this, alumina, titania, silica, molten silica, cordierite, or the like may be used. In addition to water, a binder such as methyl cellulose, a surface-active agent, a lubricant such as a vegetable oil, a plasticizing agent, and the like may be added.

Bulk bodies B including carbon having a shape of 30 mm*50 mm*5 mm were prepared. Bulk bodies C were prepared in the same way as the preparation of the bulk bodies A instead of adding silica sol, which is Si oxide and an addition agent, as an inorganic binder.

The bulk bodies A were contacted each other in a range of 20 mm*35 mm and were fired at 1350° C. in an Ar gas atmosphere at normal pressure to prepare a test piece of the sample 1 configured by joining the bulk body A (containing silicon particles and simulating a substrate) to another bulk body A (containing silicon particles and simulating an electrode). The bulk body C (containing silicon particles and silica sol and simulating a substrate) and the bulk body B (simulating a carbon electrode) were contacted each other in a range of 20 mm*35 mm and were fired at 1350° C. in an Ar gas atmosphere at normal pressure to prepare a test piece of the sample 2 configured by joining the bulk body C to the bulk body B. The bulk body A and the bulk body B were contacted each other in a range of 20 mm*35 mm and were fired at 1350° C. in an Ar gas atmosphere at normal pressure to prepare a test piece of the sample 3 configured by joining the bulk body A (containing silicon particles and simulating a substrate) to the bulk body B (simulating a carbon electrode).

A compressive load was applied to each of the prepared test pieces to record, as a breaking load, a load by which detachment is caused in a junction part. As a result, the breaking load of the test piece of the sample 1 was 286 N, the breaking load of the test piece of the sample 2 was 76 N, and the breaking load of the test piece of the sample 3 was 20 N. From the result, it was confirmed that when each of the honeycomb substrate and the electrode includes silicon particles, the junction between the honeycomb substrate and the electrode becomes tighter.

In addition, observing the cross section of the bulk body A of the sample 1 by using a scanning electron microscope (SEM) found that a conductive path was formed of a plurality of successive silicon particles in the insulating ceramic. According to the result of an EPMA analysis, it was confirmed that an oxide containing silicon and boron is present so as to cover the successive silicon particles. It is considered that this is because silicon particle-derived silicon reacts with boric acid-derived boron and oxygen.

The present disclosure is not limited to the above-described embodiments and experimental examples and can be variously changed within a scope not deviating from the gist of the present disclosure. The present disclosure has been described on the basis of the embodiments, but it is understood that the present disclosure is not limited to the embodiments, the structures, and the like. The present disclosure includes various modified examples and modifications within an equivalent range. In addition, a category and range of thought of the present disclosure include various combinations and forms and other combinations and forms including only one element, one or more elements, or one or less elements of those.

An aspect of the present disclosure provides a honeycomb substrate (1) with an electrode. The honeycomb substrate includes: a conductive ceramic honeycomb substrate (2) that generates heat by energization; and a pair of electrodes (3) that is provided to face an outer periphery of the honeycomb substrate. A coefficient of thermal expansion of the electrode is higher than a coefficient of thermal expansion of the honeycomb substrate.

The honeycomb substrate with an electrode can reduce heat stress which is generated by the difference of thermal expansion due to the temperature difference between the substrate and the electrode caused when mainly the substrate is heated by energization.

What is claimed is:

1. A honeycomb substrate with an electrode, the honeycomb substrate comprising:
a conductive ceramic honeycomb substrate that generates heat by energization; and
a pair of film-shaped electrodes that is provided to face an outer periphery of the honeycomb substrate, wherein
the electrode is directly joined to the honeycomb substrate,
a coefficient of thermal expansion of the electrode is higher than a coefficient of thermal expansion of the honeycomb substrate, and
a relationship Qₕ/Cₕ>Qₑ/Cₑ is established, where a Joule heating value of the honeycomb substrate per hour at the time of energization is Qₕ, a heat capacity of the honeycomb substrate is Cₕ, a Joule heating is value of the electrode per hour at the time of energization is Qₑ, and a heat capacity of the electrode 3 is Cₑ.

2. The honeycomb substrate with an electrode according to claim 1, wherein
a ratio between the coefficient of thermal expansion of the honeycomb substrate and the coefficient of thermal expansion of the electrode is in a range of 1:1.1 to 1:3.

3. The honeycomb substrate with an electrode according to claim 1, wherein
a ratio between a heat capacity of the honeycomb substrate and a heat capacity of the electrode is in a range of 10:1 to 300:1.

4. The honeycomb substrate with an electrode according to claim 1, wherein
the honeycomb substrate includes a silicon particle.

5. The honeycomb substrate with an electrode according to claim 1, wherein
the electrode includes a silicon particle.

6. The honeycomb substrate with an electrode according to claim 1, wherein
each of the honeycomb substrate and the electrode includes a silicon particle.

7. The honeycomb substrate with an electrode according to claim 4, wherein
at least one of the honeycomb substrate and the electrode includes an oxide including silicon and boron.
